(19) United States
(12) Patent Application Publication
(10) Pub. No.: US 2017/0291489 A1
(43) Pub. Date: Oct. 12, 2017

(54) DRAINAGE CONNECTOR

(71) Applicants: Bruno JACKSTEIT, Hammersbach (DE); Andreas BAUER, Obernburg (DE); Stephan SENFTLEBEN, Ronneburg (DE)

(72) Inventors: Bruno JACKSTEIT, Hammersbach (DE); Andreas BAUER, Obernburg (DE); Stephan SENFTLEBEN, Ronneburg (DE)

(73) Assignee: NORMA GERMANY GmbH, Maintal (DE)

(21) Appl. No.: 15/512,720

(22) PCT Filed: Sep. 15, 2015
(86) PCT No.: PCT/EP2015/071037

§ 371 Date: Mar. 20, 2017

(30) Foreign Application Priority Data
Oct. 7, 2014 (DE) 10 2014 114 486.4

(51) Int. Cl. B60K 15/077; B01D 17/02; F16K 3/24; F16K 27/04; F16K 24/02; F16K 31/528

(52) U.S. Cl. CPC B60K 15/077; F16K 24/02; F16K 31/528; F16K 3/24; F16K 27/041; B01D 17/0214; B60K 2015/03473

(57) ABSTRACT

The invention relates to a drainage connector (1) having a cup-shaped housing (2) which comprises a housing base (3) and a housing wall (4). A connection geometry (5) is arranged on the outside on the housing wall (4) for inserting into a container opening, wherein an inlet pipe (9) of an inlet side (7) is guided to an outlet side (8) through the housing base (3) and an annular collecting chamber (10) is formed between the inlet pipe (9) and the housing wall (4). In order to discharge denser fluid which can accumulate in the collecting chamber, the housing (2) has a discharge channel (11), which leads from the collecting chamber (10) to the outlet side (8) and can be closed from the outlet side (8). The drainage connector is intended to be producible in a cost-effective manner at low cost and to have a low mass. For this purpose, the inlet pipe (9) on the outlet side (8) merges into an outlet pipe (13) which has a closing element (16) that can be moved between an open position and a closed position, wherein the housing (2) comprising the connection geometry (5), the inlet pipe (9) and the outlet pipe (13) is formed from plastic as a single piece.

The invention relates to a drainage connector for separately discharging liquids of different densities, in particular such as water and fuel, according to the precharacterizing clause of claim 1.

A drainage connector of this type is used for example in conjunction with a fuel tank to discharge water, which has collected at the base of the tank, via a discharge channel by opening a valve element which is possibly formed as a screw. The drainage connector at the same time then provides an outlet for the fuel which is continuously extracted during operation. However, it can likewise be necessary to close the outlet for the fuel for service work. To this end, the prior art proposes connecting, at the outlet of the drainage connector, a valve unit to which an outlet pipe is then attached which has a connection geometry for the connection of subsequent lines.

Drainage connectors of this type are therefore composed of a relatively high number of individual parts, wherein at least the valve unit is generally made from metal in order to be sufficiently resistant. The drainage connectors known from the prior art are therefore relatively heavy on the one hand and, on the other, can only be manufactured in a relatively complex and thus cost-intensive manner. At the same time, there is a risk of leaks owing to the necessary attachment points.

The object on which the invention is now based is to prevent the disadvantages of the prior art and to provide a drainage connector which, in particular, can be manufactured cost-effectively with little complexity and which has a low mass. It should furthermore be difficult for faulty operation to occur.

This object is achieved by a drainage connector having the features of claim 1. Advantageous embodiments are the subject matter of claims 2 to 12.

In a drainage connector having a cup-shaped housing which comprises a housing base and a housing wall, wherein a connection geometry is formed on the outside of the housing wall for insertion into a container orifice, and wherein an inlet pipe is guided from an inlet side to an outlet side through the housing base, and an annular collecting chamber, which is open to the inlet side, is formed between the inlet pipe and the housing wall, wherein the housing has a discharge channel which leads from the collecting chamber to the outlet side and can be closed from the outlet side, provision is made according to the invention that, on the outlet side, the inlet pipe merges into an outlet pipe which has a closing element which can be moved between an open position and a closed position, wherein the housing with the connection geometry, the inlet pipe and the outlet pipe is formed from plastic material as a single piece.

In the open position of the closing element, a drainage of liquid through the inlet pipe and the outlet pipe is enabled here whilst, in the closed position, a free flow cross-section in the outlet pipe can be blocked by the closing element so that no liquid can flow out.

With this, the liquid with a lower density, for example such as a fuel, can be extracted via the inlet pipe and the outlet pipe, and the liquid with a higher density, for example such as water, can be extracted from the container via the discharge channel. The drainage connector therefore provides a combination for the separate drainage of two liquids of different densities, such as water and fuel, which, with the exception of the respective valve elements, can be manufactured from plastic material as a single piece, for example as an injection molded part. The complexity involved in the manufacture is therefore minimal. There are no coupling points formed within the drainage connector here, which means that leaks cannot occur. The use of plastic material results in simple manufacture on the one hand, a reduction in mass by comparison with components made of metal on the other and thus a saving on fuel consumption, for example when used in motor vehicles. It is easily possible here to use plastic materials which are resistant to oxidation and the substances contained in the liquids.

The closing element is preferably also formed from a plastic material here, in particular as an injection-molded part. The closing element can then likewise be manufactured in the desired form in economical manner and with a low mass. The closing element and the housing here can be manufactured from the same plastic material or from different plastic materials.

To ensure that only the liquid with the lower density flows off via the inlet pipe and the outlet pipe, the inlet pipe preferably has a larger extent on the entry side than the connection geometry. The inlet pipe therefore extends further into a container than the connection geometry so that the liquid located near to the base can only be extracted via the discharge channel. In particular, when used in fuel tanks, the operational reliability is therefore high since it is thus possible to reliably prevent water from the fuel tank arriving at the engine.

The inlet pipe preferably leads into an outlet pipe wall of the outlet pipe, wherein the outlet pipe extends in particular substantially perpendicularly to the inlet pipe. Therefore, the inlet pipe does not merge flush into the outlet pipe but opens into its outlet pipe wall so that the outlet pipe, starting from the opening, extends in two directions. This results in a particularly favorable embodiment in that the outlet pipe and the inlet pipe are arranged in a T shape with respect to one another, i.e. extend perpendicularly to one another.

The discharge channel, which serves to convey the liquid with the higher density out of the collecting chamber, can be closed by a valve element which is guided in particular perpendicularly to the discharge channel and is possibly formed as a screw. This results in a simple and space-saving option for reliably closing the discharge channel.

The discharge channel here advantageously has a stepped form in the valve region. A discharge orifice of the discharge channel can be arranged at a greater spacing from the housing as a result of this step. At the same time, more space is available for the valve element.

In a particularly preferred embodiment, the closing element is inserted into the outlet pipe by an end face and is axially displaceably mounted in the outlet pipe, wherein a sliding block guideway is formed in particular between an outlet pipe wall and the closing element. Starting from the opening of the inlet pipe into the outlet pipe, the one half of the outlet pipe is therefore used to receive and guide the closing element, whilst the liquid can be conveyed away via the other half. The closing element is thus accommodated in the outlet pipe in a manner which is very stable and not susceptible to dirt. As a result of the sliding block guideway, a rotational movement which is introduced into the closing element from the outside, is converted into a combined movement in the radial and axial direction, whereby the closing element is moved into or out of the outlet pipe.

The closing element is thereby moved between an open position and a closed position. An unintentional actuation, for example as a result of an object falling against the closing element, is almost impossible here. Additional security can be achieved in that, in the end positions of the sliding block guideway, which correspond to the closed position and the open position, latching means are provided and/or the sliding block guideway extends in the circumferential direction. The closing element is thus securely positioned in the closed position and the open position.

The closing element preferably has an annular chamber, wherein, in the open position, the annular chamber is positioned in the region of an opening of the inlet pipe into the outlet pipe. A sealing is then effected in the outlet pipe via this annular chamber when the closing element is located in the closed position. The annular chamber here is preferably formed in that, in this region, an outside diameter is smaller than an inside diameter of the outlet pipe. The annular chamber is then delimited axially in each case by at least one region having a larger diameter, in particular by radially outwardly projecting circumferential collars. These then serve for the actual sealing, wherein they are possibly provided with additional sealing elements to also rule out leaks at higher pressures.

The annular chamber is advantageously at least as long in the axial direction as the diameter of the inlet pipe. The opening is then completely covered by the annular chamber in the closed position of the closing element.

In the open position, the closing element is preferably positioned completely on one side of the opening of the inlet pipe in the outlet pipe. In normal operation, the closing element therefore lies completely outside the flow path and does not offer any flow resistance. The liquid can therefore flow off freely through the other side of the outlet pipe in the open position of the closing element.

In the open position and in the closed position, the closing element projects particularly advantageously out of the outlet pipe at one end. The closing element is therefore easily actuable from the outside at its projecting end in every position.

For better sealing, sealing elements can be arranged in particular on both sides of the annular chamber between the closing element and the outlet pipe wall, which sealing elements are held in particular in annular grooves which are formed in the closing element or the outlet pipe wall. Leaks can therefore also be reliably prevented at higher pressures.

An inside diameter of the outlet pipe can be smaller on the half via which the liquid is discharged than on the half in which the closing element is arranged. An outside diameter of the closing element or the collar on the side of the annular chamber which faces the half of the outlet pipe via which the liquid is conveyed away can then likewise be smaller than on the other side. With the displacement of the closing element, a sealing element is prevented from extending into the opening to the inlet pipe and being placed under a mechanical load as a result. A long useful life is achieved in this way.

In a preferred embodiment, an end of the outlet pipe which is remote from the closing element has a connection geometry. This connection geometry can then be matched to a particular attachment system or standardized line connections to enable easy connection of subsequent lines. The connection geometry can then also comprise latching attachments and the like.

The closing element preferably has radially outwardly projecting guide ribs which abut against an inside wall of the outlet pipe, in particular in a region of the outlet pipe which has an increased diameter. The closing element itself can therefore be kept relatively slim and is supported against the inside wall substantially only by the guide ribs. A saving on material, and therefore weight, and a relatively low-friction bearing are achieved as a result.

In a preferred further development, the closing element comprises a head which has a greater diameter than the guide ribs and than a greatest inside diameter of the outlet pipe. A torque application surface can then be formed on the head. An actuation of the closing element via the head is therefore relatively easily possible, wherein, as a result of the increased diameter of the head, a greater mechanical stability is achieved and actuation without a tool is possibly also enabled.

The closing element preferably has at least one blind hole which is formed in particular such that it is open to the side remote from the opening of the inlet pipe. The blind hole therefore starts from the head. A saving in material and weight is achieved as a result.

To this end, a blind hole can also be alternatively or additionally provided, which is open to the end of the closing element which is remote from the head. The closing element is therefore of a hollow design with the exception of a wall between the mutually flush blind holes.

A bearing surface, whereof the diameter is greater than an inside diameter of the outlet pipe, can be formed on the head. In a closed position, this bearing surface then comes to bear against an end face of the outlet pipe and prevents a further movement of the closing element into the outlet pipe. A distinct end position is therefore defined.

In a preferred embodiment, a cap is arranged on the closing element, which cap extends in the direction of the inlet pipe and surrounds the outlet element, wherein it is latched in particular to the closing element, wherein the head of the closing element possibly projects through the cap. This cap protects the sliding block guideway and the parts of the closing element which can be moved out of the outlet pipe from dirt. Impurities are also prevented from penetrating between the closing element and the inside wall of the outlet pipe, which would lead to leaks. The cap here can also remained fastened on the drainage connector during the actuation of the closing element.

In an alternative embodiment, a cap is provided which, in the fitted state, covers the end of the closing element which projects out of the outlet pipe and covers the outlet pipe, at least over an axial length which corresponds to an adjustment path of the closing element from the open position into the closed position, wherein the cap is held on the outlet pipe in particular by a securing device. This cap can be fastened for example with friction fit to the outlet pipe and reliably protects the closing element and the inside of the outlet pipe from dirt. However, to actuate the closing element, this cap has to be removed, wherein the cap is prevented from becoming lost by the securing device which is formed for example by a band-shaped element which is fastened by one end to the connection pipe and by another end to the cap. The cap and the securing device can be formed here for example as a plastic part in a single piece.

On the outside of the housing wall of the drainage connector, a ring seal is preferably arranged on the base-side end of the connection geometry, wherein a radially outwardly projecting stop is formed in particular on the side of the ring seal which is remote from the connection geometry. The drainage connector can thus be inserted into a container orifice in reliably fluid-tight manner. The insertion is particularly simple here if the connection geometry is designed as an outside thread.

Further features, details and advantages of the invention are revealed in the wording of the claims and in the description below of exemplary embodiments with reference to the drawings, which show:

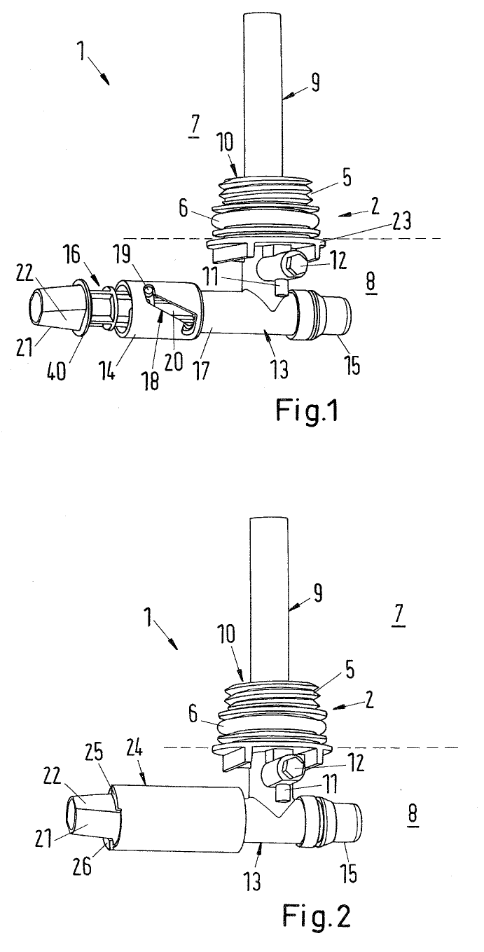

FIG. 1 a drainage connector in a three-dimensional illustration;

FIG. 2 the drainage connector according to FIG. 1 with a cap;

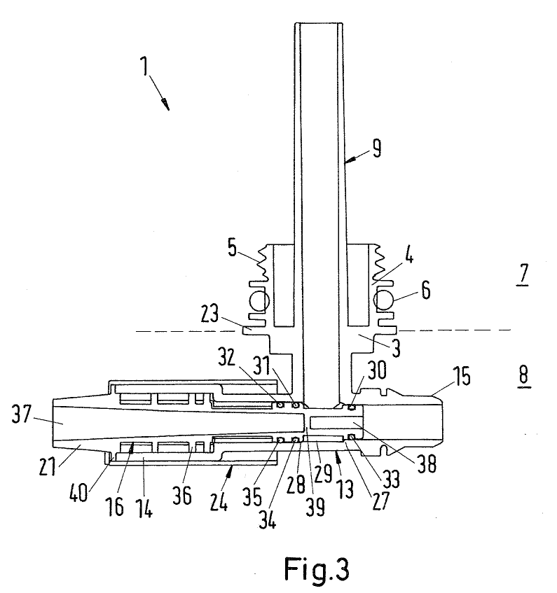

FIG. 3 the drainage connector according to FIG. 2 in a sectional illustration;

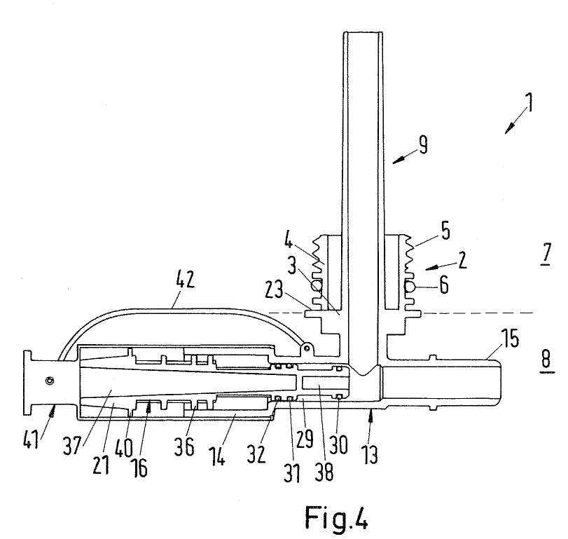

FIG. 4 the drainage connector in a sectional illustration with an alternative cap.

FIG. 1 shows a drainage connector 1 in a three-dimensional illustration, which can be inserted into a container orifice in order to enable liquids of different densities to be discharged separately from one another. The drainage connector 1 has a cup-shaped housing 2 having a housing base 3 and a housing wall 4 (see FIGS. 3 and 4), wherein a connection geometry 5 in the form of an outside thread is integrally formed on an outside of the housing wall 4. The drainage connector can moreover be screwed into a corresponding container orifice, for example of a fuel tank, in fluid-tight manner until a radially outwardly projecting circumferential stop 23 comes to bear against an outside of the container. For additional sealing, in the exemplary embodiment shown, a ring seal 6 is provided on the base-side end of the connection geometry 5, which ring seal is held in an annular groove which is integrally formed in the housing wall 4.

The housing base 3 separates an inlet side 7, which lies for example inside a fuel tank, from an outlet side 8, which is accessible for a user. To direct fuel away, for example, the drainage connector comprises an inlet pipe 9 which is formed in a single piece with the housing 2 and penetrates through the housing base 3. The inlet pipe, which projects into the container when the drainage connector is fitted, thereby produces a fluid-directing connection between the inlet side 7 and the outlet side 8.

An annular collecting chamber 10 is formed on the inlet side, between the inlet pipe 9 and the housing wall 4. When the drainage connector 1 is fitted, the liquid with the higher density collects in the collecting chamber 10 and can be discharged via a discharge channel 11 which opens into the collecting chamber 10 and leads to the outlet side 8. It is, for example, thereby possible for water collecting in a fuel tank to be discharged via the discharge channel 11 without likewise allowing the fuel, which has a lower density than water, to be discharged at the same time. The fuel is then conveyed away during operation via the inlet pipe 9, which extends further than the housing wall 4 on the inlet side, i.e. into the container.

For the controlled discharge of the liquid out of the collecting chamber 10, a valve element 12 is provided which closes and opens the discharge channel. The valve element 12, which is formed as a screw in the illustrated exemplary embodiment, is freely accessible here from the exit side 8.

The inlet pipe 9 merges on the exit side 8 into an outlet pipe 13 which is formed in a single piece with the inlet pipe 9. The inlet pipe 9 and the outlet pipe 13 are arranged in a T shape here so that the outlet pipe 13 has two free ends 14, 15.

Whilst liquid, in particular fuel, can be conveyed away via the end 15 and a connection geometry is integrally formed on the end 15 for the connection of subsequent lines, a closing element 16 is inserted into the other end 14. The closing element can be moved axially between an open position, in which liquid flows out of the inlet pipe 9 into the outlet pipe 13, into a closed position in which a through-flow is prevented.

A sliding block guideway 18 is formed between an outlet pipe wall 17 and the closing element 16 so that, when a rotational movement is introduced into the closing element 16, this also moves axially with respect to the outlet pipe 13. In the illustrated exemplary embodiment, the sliding block guideway 18 is formed by a pin 19 of the closing element 16 in conjunction with a groove 20 which is incorporated in the outlet pipe wall 17. The groove 20 extends here in a circumferential direction at its ends so that the closing element 16 is secured in its respective end positions, which correspond to the open position and closed position. The groove 20 can additionally be provided with a latching means there, for example in the form of a brief narrowing.

To introduce a rotational movement into the closing element 16, torque application surfaces 22 are integrally formed on a head 21 of the closing element 16, which torque application surfaces can be actuated for example by a spanner. The head 21 is located outside the outlet pipe 13 here both in the closed position (illustrated in FIG. 3) and the open position (illustrated in FIG. 1) of the closing element 16.

FIG. 2 shows the drainage connector according to FIG. 1, wherein a cap 24 is provided which covers the sliding block guideway 18 and thus part of the outlet pipe 13. The cap 24 is cylindrical in form and has an opening in its base through which the head 21 of the closing element 16 extends. The cap 24 is held in latching manner on the head 21 by radially inwardly projecting latching arms 25, 25 so that it is moved at least axially with the closing element 16 upon a movement of this latter. The cap 24 has an axial extent here, which corresponds at least to the length of the adjustment path of the closing element so that, both in the open position and in the closed position, the sliding block guideway and the part of the closing element 16 which projects out of the outlet pipe 13 are also covered with the exception of the head 22 and are thus protected from dirt. With this embodiment of the cap 24, an actuation of the closing element 16 is possible without previously removing the cap 24.

FIG. 3 shows the drainage connector 1 according to FIG. 2 in a sectional illustration, wherein the closing element 16 is located in the closed position. The closing element 16 here has an annular chamber 29 which is formed between two radially outwardly projecting collars 27, 28 and is sealed axially by sealing elements 30, 31, 32 which is sealed in corresponding annular grooves 33, 34, 35 which are formed in the collars 27, 28. The annular chamber 29 extends here axially at least to the extent that it can completely cover the opening of the inlet pipe 9. As soon as the closing element 16 is in the closed position, liquid is therefore prevented from flowing out of the outlet pipe 13.

Since the outlet pipe 13 has a smaller inside diameter in the direction towards the outlet end 15 than in the opposite direction starting from the opening of the inlet pipe 9, the collar 27 and the sealing element 30 likewise have a smaller diameter than the collar 28 and the sealing elements 31, 32. The sealing element thus loses its contact with the inside wall of the outlet pipe 13 upon the displacement of the closing element 16 from the closed position into the open position. Since the diameter is already increased in the opening region, this prevents the seal from expanding into the inlet pipe 9 during the displacement, which would place it under a heavy load. On the whole, a relatively long useful life of the sealing element 30 is achieved in this way.

The outlet pipe 13 has an increased diameter in the region of the end 14 in which the sliding block guideway is also formed. The closing element 16 is supported on the inside of the outlet pipe 13 in this region by guide ribs 36. This results in a stable bearing. The necessary adaptation of the diameter of the closing element to the outlet pipe is provided here by these guide ribs whilst the actual body of the closing element retains a substantially constant diameter. This results in a saving on material and thus on cost and weight.

For a further saving on weight, the closing element 16 is provided with two mutually flush blind holes 37, 38 which start one from the head 21 and one from the opposing end face. A wall 39, which prevents liquid from flowing out, remains between the blind holes.

A circumferential bearing surface 40, which has a greater diameter than the greatest inside diameter of the outlet pipe 13, is located on the head 21. In the closed position illustrated in FIG. 3, the bearing surface 40 abuts with its end face against the outlet pipe 13 and prevents the closing element from rotating in further. The load on the pin 19 of the sliding block guideway 18 is therefore relieved.

FIG. 4 shows the outlet connector 1 with an alternative embodiment of the cap 41. In contrast to the cap 24 in the embodiment described above, the cap 41 in this embodiment has to be removed before the actuation of the closing element. The cap 41 is held on the outlet pipe 13 here by a resilient securing device 42 in such a way that it cannot be removed completely even after it has been taken off.

The cap 41 has a length here which is sufficient to also be able to receive the closing element 16 in its open position, which is then in its maximally withdrawn position. With this, the cap 41 covers at least the region of the outlet pipe 13 in which the sliding block guideway is arranged. This is protected accordingly from dirt. In the simplest case, the cap 41 is held on the outlet pipe 13 by press fit, i.e. by friction fit, and can therefore be pulled off relatively easily if required.

The invention is not restricted to one of the embodiments described above, but can be modified in a variety of ways. Therefore, the annular chamber can be formed for example by a constriction and the closing element can moreover have a constant diameter. It is also conceivable for the outlet pipe to be arranged at a different angle to the inlet pipe rather than perpendicularly. The outlet pipe can also possibly be connected with material fit to the inlet pipe by means of plastic welding or another method, if this brings about production-related advantages.

All of the features and advantages demonstrated in the claims, the description and the drawing, including structural details, spatial arrangements and method steps, can be fundamental to the invention in themselves and also in a wide range of combinations.

### LIST OF REFERENCE SIGNS

1 Drainage connector
2 Housing
3 Housing base
4 Housing wall
5 Connection geometry
6 Ring seal
7 Inlet side
8 Outlet side
9 Inlet pipe
10 Collecting chamber
11 Discharge channel
12 Valve element
13 Outlet pipe
14 End
15 End
16 Closing element
17 Outlet pipe wall
18 Sliding block guideway
19 Pin
20 Groove
21 Head
22 Torque application surface
23 Stop
24 Cap
25 Latching arm
26 Latching arm
27 Collar
28 Collar
29 Annular chamber
30 Sealing element
31 Sealing element
32 Sealing element
33 Annular groove
34 Annular groove
35 Annular groove
36 Guide ribs
37 Blind hole
38 Blind hole
39 Wall
40 Bearing surface
41 Cap
42 Securing device

1. A drainage connector (1) having a cup-shaped housing (2) which comprises a housing base (3) and a housing wall (4), wherein a connection geometry (5) is formed on the outside of the housing wall (4) for insertion into a container orifice, wherein an inlet pipe (9) is guided from an inlet side (7) to an outlet side (8) through the housing base (3) and a collecting chamber (10) is formed between the inlet pipe (9) and the housing wall (4), wherein the housing (2) has a discharge channel (11) which leads from the collecting chamber (10) to the outlet side (8) and can be closed from the outlet side (8), characterized in that, on the outlet side (8), the inlet pipe (9) merges into an outlet pipe (13) which has a closing element (16) which can be moved between an open position and a closed position, wherein the housing (2) with the connection geometry (5), the inlet pipe (9) and the outlet pipe (13) is formed from plastic material as a single piece.

2. The drainage connector as claimed in claim 1, characterized in that the inlet pipe opens into an outlet pipe wall (17) of the outlet pipe (13), wherein the outlet pipe (13) extends in particular substantially perpendicularly to the inlet pipe (9).

3. The drainage connector as claimed in claim 1, characterized in that the discharge channel (11) can be closed by a valve element (12) which is guided in particular perpendicularly to the discharge channel (11) and is possibly formed as a screw.

4. The drainage connector as claimed in claim 1, characterized in that the closing element (16) is inserted into the outlet pipe (13) by one end (14) and is axially displaceably mounted in the outlet pipe (13), wherein a sliding block guideway (18) is formed in particular between an outlet pipe wall (17) and the closing element (16).

5. The drainage connector as claimed in claim 1, characterized in that the closing element (16) has an annular chamber (29), wherein, in the open position, the annular chamber (29) is positioned in the region of an opening of the inlet pipe (9) into the outlet pipe (13).

6. The drainage connector as claimed in claim 1, characterized in that, in the closed position, the closing element (16) is positioned completely on one side of the opening of the inlet pipe (9) in the outlet pipe (13).

7. The drainage connector as claimed in claim 1, characterized in that sealing elements (30, 31, 32) are arranged in particular on both sides of the annular chamber (29) between the closing element (16) and the outlet pipe wall (17), which sealing elements are held in particular in annular grooves (33, 34, 35) which are formed in the closing element (16) or the outlet pipe wall (17).

8. The drainage connector as claimed in claim 1, characterized in that the closing element (16) has radially outwardly projecting guide ribs (36) which abut against an inside wall of the outlet pipe (13), in particular in a region of the outlet pipe (13) which has an increased diameter.

9. The drainage connector as claimed in claim 1, characterized in that the closing element (16) has at least one blind hole (37, 38) which is formed in particular such that it is open to the side remote from the opening of the inlet pipe (9).

10. The drainage connector as claimed in claim 1, characterized in that a cap (24) is arranged on the closing element (16), which cap extends in the direction of the inlet pipe (9) and surrounds the outlet pipe (13), wherein it is latched in particular to the closing element (16), wherein a head (21) of the closing element (16) possibly projects through the cap (24).

11. The drainage connector as claimed in claim 1, characterized in that a cap (41) is provided which, in the fitted state, covers the end of the closing element (16) which projects out of the outlet pipe (13) as well as the outlet pipe (13), at least over an axial length which corresponds to an adjustment path of the closing element (16) from the open position into the closed position, wherein the cap (41) is held on the outlet pipe (13) in particular by a securing device (42).

12. The drainage connector as claimed in claim 1, characterized in that, on the outside of the housing wall (4), a ring seal (6) is held on the base-side end of the connection geometry (5), wherein a radially outwardly projecting stop (23) is formed in particular on a side of the ring seal (6) which is remote from the connection geometry (5).
